(19) United States
(12) Patent Application Publication
(10) Pub. No.: US 2026/0312667 A1
(43) Pub. Date: Oct. 8, 2026

(54) TRAFFIC AWARE BEAM MANAGEMENT FOR BEAM SWITCHING ACCELERATION

(71) Applicant: Google LLC, Mountain View, CA (US)

(72) Inventors: Yushu ZHANG, Beijing (CN); Chih-Hsiang WU, Taipei City (TW); Abdellatif SALAH, London (GB)

(21) Appl. No.: 19/483,598

(22) PCT Filed: May 16, 2023
(86) PCT No.: PCT/CN2023/094456

§ 371 Date: Nov. 11, 2025

(51) Int. Cl. H04B 7/06; H04B 17/309; H04L 5/00

(52) U.S. Cl. CPC H04B 7/06968; H04B 17/309; H04L 5/0048

(57) ABSTRACT

This disclosure provides systems, devices, apparatus, and methods, including computer programs encoded on storage media, for beam management for beam switching acceleration. A UE receives (408, 908), from a network entity, a plurality of beams for signal quality measurements. The UE communicates with the network entity via a first beam of the plurality of beams. The UE transmits (424, 524, 624, 724, 824, 924) to the network entity, a message indicating accelerating a beam switching from the first beam to a second beam of the plurality of beams based on a signal quality of the second beam being higher than a signal quality of the first beam and the signal quality of the first beam exceeding a threshold for a traffic type.

### TECHNICAL FIELD

The present disclosure relates generally to wireless communication, and more particularly, to beam management in wireless communications.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, wireless extended reality (XR) communications offer better freedom of movement as wireless eliminates the geographical or behavioural restrictions and allows XR users to move freely. However, it is difficult to achieve high data rates, high reliability, and low latency of the XR communications on the wireless network.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

XR includes Augmented Reality (AR), Virtual Reality (VR) and Mixed Reality (MR). The XR traffic includes the traffic flow of downlink (DL) VR traffic or uplink (UL) AR traffic, and the UL traffic flow to send the pose/control information which reflects the user position and movement to adjust the AR/VR content. XR traffic is a quasi-periodic traffic with the period equal to the inverse of the XR frame rate. In some scenarios, the XR traffic suffers from jitter due to the delay variations to encode the video frames.

XR traffic requires high data rates, high reliability, and low latency. This may be challenging to achieve on the wireless network, which is sensitive to fading, mobility, etc. XR traffic is sensitive to events that can disturb the transmission of UL AR video traffic or the DL VR video traffic. The events include beam switching, bandwidth part (BWP) switching, channel state information (CSI) measurement and reporting, and/or radio resource management (RRM) measurements. Some of the events can cause latency and jitter in the XR traffic and reduce/disturb the quality of experience (QoE) of the user.

For example, a beam switching procedure can include beam indication from a network (NW) entity, a user equipment (UE)-triggered beam failure recovery, and/or a random access channel (RACH) procedure (excluding a physical downlink control channel (PDCCH) ordered physical random access channel (PRACH), which is for primary cell (PCell)-only). To complete the beam switching procedure, the UE identifies a first parameter for the UE beam to correspond to the new NW beam, a second parameter for DL quasi co-location (QCL) Type A related parameters, and a third parameter for UL power control pathloss. The time delay for the UE to identify the three parameters can cause latency and disturb XR communications.

The present disclosure addresses the above-noted and other deficiencies by speeding up or accelerating the beam switching procedure. In some examples, when the new beam is of better quality than the old beam, and the old beam cannot provide a threshold level of performance to support the XR traffic, the UE accelerates the beam switching to the new beam. For example, the UE accelerates the procedure to identify the beam switching parameters to reduce the interruption time of the XR communications.

As an example, beam indication signalling, beam failure recovery (BFR) response, and/or random access response (RAR) can trigger an aperiodic CSI-reference signal (CSI-RS) to speed up the procedure to identify the beam switching parameters. The UE may identify the beam switching parameters based on the aperiodic CSI-RS. Downlink control information (DCI) and/or RAR may be enabled to trigger the aperiodic CSI measurement and reporting.

As another example, the UE may measure and store the beam switching parameters during the beam measurement procedure before the beam switching. The UE can identify the most likely beam or a top N number of beams to measure and store the corresponding beam switching parameters. The NW may configure one or multiple conditions for the UE to start measuring and storing the parameters (e.g., link deterioration, block error rate (BLER), packet error rate (PER), latency, etc.). The UE may send a message to the NW indicating whether the UE has measured and stored the beam switching parameters for specific beams.

Yet as another example, the UE can use the layer 1 (L1)-reference signal received power (RSRP) for pathloss measurement. The UE may use the L1-RSRP for the pathloss measurement only for the transition time (e.g., before the UE measures the layer 3 (L3)-RSRP). The NW can configure a set of uplink power control parameter(s), e.g., higher value of PO, during this transition time.

Still as another example, the UE can measure and report the channel quality information (CQI) or a simplified CQI for each beam, e.g., synchronization signal block (SSB), in a beam report, BFR request, and message(s) to the NW. The UE may measure and report for the top N beams or all beams. The NW may configure the number of beams N. The number of beams N may also be based on a predefined protocol.

For another example, the UE may perform beam failure detection for XR communications using a different or lower BLER threshold. The NW may configure the different or lower BLER threshold, e.g., by a radio resource control (RRC) signal.

According to some aspects, the UE receives, from a network entity, a plurality of beams for signal quality measurements. The UE communicates with the network entity via a first beam of the plurality of beams. The UE transmits to the network entity, a message indicating accelerating a beam switching from the first beam to a second beam of the plurality of beams based on a signal quality of the second beam being higher than a signal quality of the first beam and the signal quality of the first beam exceeding a threshold for a traffic type.

According to some aspects, the network entity transmits, to a UE, a plurality of beams for signal quality measurements. The network entity communicates with the UE via a first beam of the plurality of beams. The network entity receives, from the UE, a message indicating accelerating a beam switching from the first beam to a second beam of the plurality of beams based on a signal quality of the second beam being higher than a signal quality of the first beam and the signal quality of the first beam exceeding a threshold for a traffic type.

Advantageously, accelerating the beam switching can reduce the interruption time of the XR communications, thus, reducing the impact on the XR communications and reducing disturbance to the QoE of the user. The beam switching procedure can be enhanced by speeding up or accelerating the beam switching to allow for a transition that reduces the impact on the user experience. For example, enhancements to the beam switching can be helpful in allowing the beam switching to take place with the reduced impact on the quality of the XR video.

### BRIEF DESCRIPTION OF THE DRAWINGS

FIG. 1 illustrates a diagram of a wireless communications system that includes a plurality of user equipments (UEs) and network entities in communication over one or more cells.

FIG. 2 is a diagram illustrating an XR traffic model for XR communications.

FIG. 3 is a diagram illustrating accelerating a beam switching in XR communications between a UE and a network entity.

FIG. 4 is a signaling diagram illustrating an example of communications between a UE and a network entity for accelerating a beam switching by using an aperiodic CSI-RS.

FIG. 5 is a signaling diagram illustrating an example of communications between a UE and a network entity for accelerating a beam switching by measuring and storing the beam switching parameters before the beam switching.

FIG. 6 is a signaling diagram illustrating an example of communications between a UE and a network entity for accelerating a beam switching by using the L1-RSRP for the pathloss measurement.

FIG. 7 is a signaling diagram illustrating an example of communications between a UE and a network entity for accelerating a beam switching based on a CQI or a simplified CQI.

FIG. 8 is a signaling diagram illustrating an example of communications between a UE and a network entity for accelerating a beam switching by beam failure detection using a different BLER threshold.

FIG. 9 is a flowchart of a method of wireless communication at a UE.

FIG. 10 is a flowchart of a method of wireless communication at a network entity.

FIG. 11 is a diagram illustrating a hardware implementation for an example UE apparatus.

FIG. 12 is a diagram illustrating a hardware implementation for one or more example network entities.

### DETAILED DESCRIPTION

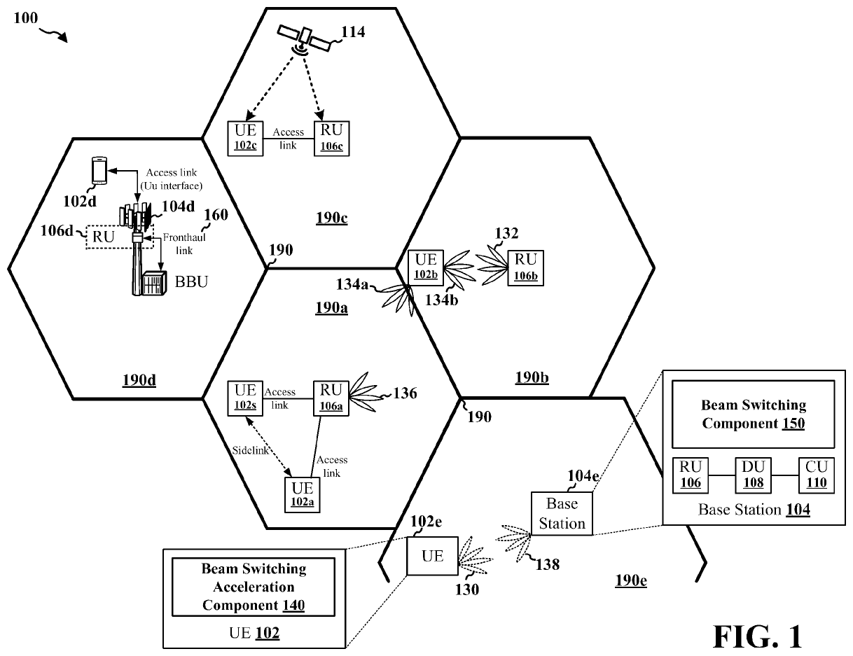

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture utilizes a radio protocol stack that is physically or logically integrated within a single radio access network (RAN) node. A disaggregated base station architecture utilizes a protocol stack that is physically or logically distributed among two or more units (e.g., radio unit (RU) 106, distributed unit (DU) 108, central unit (CU) 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Any of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106 or the DU 108), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104d/104e and/or the RUs 106a-106d may communicate with the UEs 102a-102d and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. DUs 108 can control both real-time and non-real-time features of control plane and user plane communications of the RUs 106.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 may relay communications between the UEs 102 and the core network (not shown). The base stations 104 may be associated with macrocells for higher-power cellular base stations and/or small cells for lower-power cellular base stations. For example, the cell 190e may correspond to a macrocell, whereas the cells 190a-190d may correspond to small cells. Small cells include femtocells, picocells, microcells, etc. A network that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, with more or fewer carriers allocated to either the uplink or the downlink. A primary component carrier and one or more secondary component carriers may be included in the component carriers. The primary component carrier may be associated with a primary cell (PCell) and a secondary component carrier may be associated with a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal (e.g., sounding reference signal (SRS)) to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 may or may not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a next generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station, or a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Uplink/downlink signaling may also be communicated via a satellite positioning system (SPS) 114. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

Still referring to FIG. 1, in certain aspects, any of the UEs 102 may include a beam switching acceleration component 140 configured to receive, from the network entity, a plurality of beams for signal quality measurements. The UE 102 communicates with the network entity via a first beam of the plurality of beams. The beam switching acceleration component 140 is further configured to transmit, to the network entity, a message indicating accelerating a beam switching from the first beam to a second beam of the plurality of beams based on a signal quality of the second beam being higher than a signal quality of the first beam and the signal quality of the first beam exceeding a threshold for a traffic type.

In certain aspects, any of the base stations 104 or a network entity of the base stations 104 may include a beam switching component 150 configured to transmit, to the UE 102, a plurality of beams for signal quality measurements. The network entity communicates with the UE via a first beam of the plurality of beams. The beam switching component 150 is further configured to receive, from the UE, a message indicating accelerating a beam switching from the first beam to a second beam of the plurality of beams based on a signal quality of the second beam being higher than a signal quality of the first beam and the signal quality of the first beam exceeding a threshold for a traffic type.

Accordingly, FIG. 1 describes a wireless communication system that may be implemented in connection with aspects of one or more other figures described herein. Further, although the following description may be focused on 5G NR, the concepts described herein may be applicable to other similar areas, such as 5G-Advanced and future versions, LTE, LTE-advanced (LTE-A), and other wireless technologies, such as 6G.

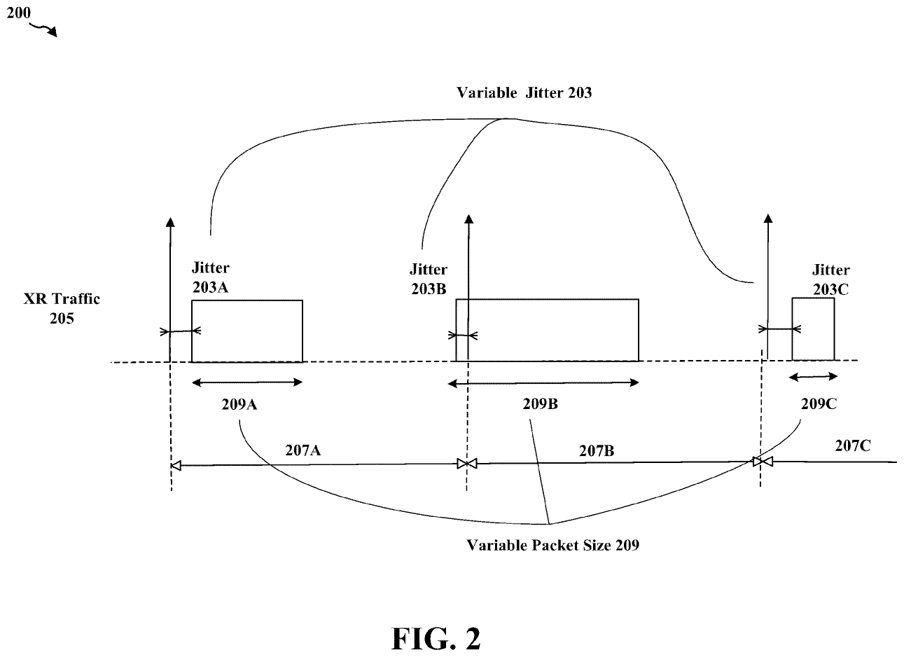

FIG. 2 is a diagram 200 illustrating an XR traffic model for XR communications. XR communications covers AR, VR, and MR communications. In VR, the user is immersed in a virtual environment that is substituting the real environment by wearing a head-mounted device. AR augments the perception of the real environment with some virtual elements, so some virtual elements are overlaid on the perception of the real environment. MR is an extension of AR where the real and virtual elements can interact in real time. Cloud gaming runs video games on remote servers without the need for a gaming console or a high specification CPU and GPU to play these games. Cloud gaming streams a game like streaming a video, and the game can respond to the gamer commands and controls in real time.

Wireless AR/VR and wireless cloud gaming offer better freedom of movement as wireless eliminates the geographical or behavioural restrictions and allows VR and AR users to move freely. Wireless AR/VR also enables new applications like remote education in immersive environment for remote areas. Multiple XR scenarios and applications are deployed. Offline sharing of 3D objects includes sharing 3D models or objects and 3D mixed reality scenes amongst users, e.g., using a phone equipped with a depth camera to capture an image in 3D and then share the image with a contact. XR conferencing is another use case and includes people interacting in virtual environment and sharing a 3D experience with each other and even presenting some content and discuss with other people in the same conference.

The XR traffic (e.g., XR communications) is a quasi-periodic traffic with the period equal to the inverse of the XR frame rate. For example, if the frame rate is 60 frames per second (fps), the periodicity is 16.67 milliseconds (ms). In some scenarios, the XR traffic suffers from jitter due to the delay variations at the codec to encode the video frames. For example, jitter is the deviation from true periodicity of a presumably periodic signal, often in relation to a reference clock signal, in electronics and telecommunications. The jitter is statistically modelled in the 3rd generation partnership project (3GPP), e.g., as a truncated Gaussian distribution. The XR packet/frame sizes are also very large and variable due to the variability in the video frame content and are also statistically modelled in 3GPP as truncated Gaussian distribution.

As illustrated in FIG. 2, the XR traffic 205, e.g., video traffic, is a quasi-periodic traffic. For example, the XR traffic 205 may have a frame rate of 60 fps. The XR traffic 205 may suffer variable jitter 203 and have a variable packet size 209. In a first period 207A, the XR traffic 205 may have a jitter 203A and have a packet size 209A. In a second period 207B, the XR traffic 205 may have a jitter 203B and have a packet size 209B. In a third period 207C, the XR traffic 205 may have a jitter 203C and have a packet size 209C, and so on. The jitter 203 may be modelled as a truncated Gaussian distribution with 0 mean, 2 ms standard deviation, and +/−4 ms range. The XR packet/frame size 209 may also be modelled as a truncated Gaussian distribution.

XR traffic may include two types of traffic flows. The first type of traffic flow is the DL VR traffic or the UL AR traffic, which is a quasi-periodic traffic. The DL VR traffic or the UL AR traffic may have a periodicity, e.g., 30 fps, 60 fps or 120 fps. The DL VR traffic or the UL AR traffic may suffer from jitter. The arrival time can vary if there is jitter, as illustrated in FIG. 2. For example, in Rel-17, the jitter for the DL VR traffic may be in the range of +/−4ms and follow a gaussian distribution. The jitter for the UL AR traffic may be smaller, but the jitter does exist, e.g., for the case of tethering (e.g., if 5G modem is on the mobile and the display is on AR glasses or VR headset). The DL VR traffic or the UL AR traffic may have variable packet sizes and follows a truncated gaussian distribution (based on RAN1 assumption in Rel-17). Bit rates of DL VR traffic or the UL AR traffic may be between 10 and 200 Mbps, depending on frame rate, resolution and codec efficiency. As an example, the latency requirement for the DL VR traffic or the UL AR traffic may be 10 ms. The DL VR traffic or the UL AR traffic may include packet data unit (PDU) sets and data burst. The data burst may be a video frame and a PDU set is one slice of the video frame. Hence, a data burst may include multiple PDU sets.

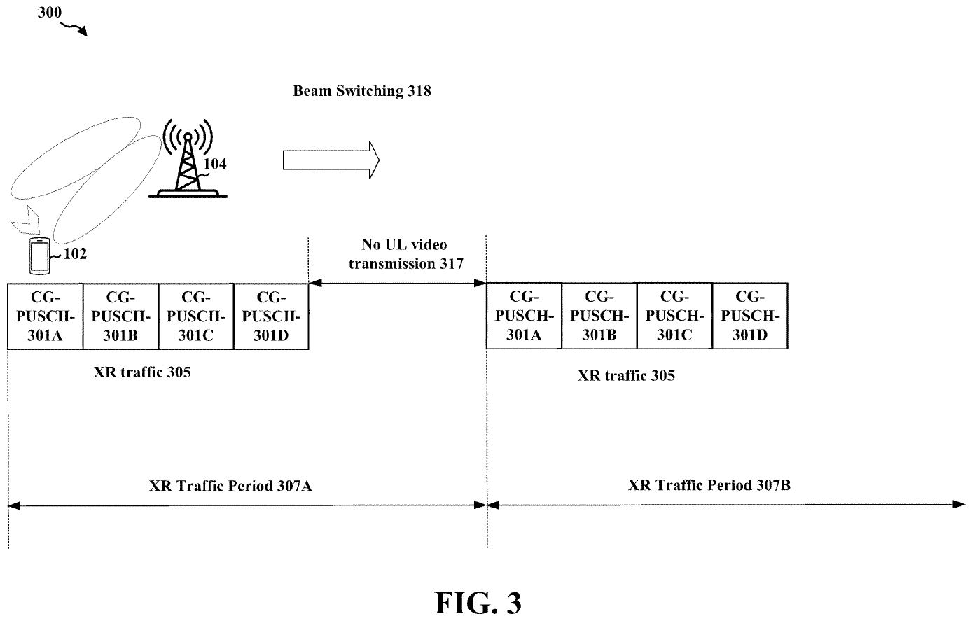

The second type of traffic flow is to send the pose/control information which reflects the user position and movement to adjust the AR/VR content. The second type of traffic flow is also associated with cloud gaming. For example, the most common discussed periodicity of the second type of traffic flow may be 4 ms, however, the same periodicity as the first type of traffic flow could be used for relaxed cases. The second type of traffic flow has no jitter. The second type of traffic flow has small packets (e.g., about 100 bytes). The latency requirements of the second type of traffic flow may be in the range of 10-20 ms. The packet loss rate of the second type of traffic flow should be lower than 10E-3. Some references for the XR traffic model may be found in: 3GPP RANI TR 38.835, RAN2 TR 38.838, SA4 TR 26.928, SA4 TR 26.918, SA4 TR 26.926. FIG. 3 discusses a beam switching acceleration in XR communications based on the XR traffic model illustrated in FIG. 2.

FIG. 3 is a diagram 300 illustrating accelerating a beam switching 318 in XR communications between a UE 102 and a network entity 104. The network entity 104 may correspond to a base station or a unit of a base station, such as the RU 106, the DU 108, the CU 110, etc.

XR traffic requires high data rates, high reliability, and very low latency. It is challenging to achieve on the wireless network, which is sensitive to fading, mobility, etc. XR traffic is sensitive to events that can disturb the transmission of UL AR video traffic or DL VR video traffic. These events can include: beam switching, bandwidth part switching, CSI measurement and reporting, and/or RRM measurements.

Some of the events can cause latency and jitter in the XR traffic and reduce/disturb the quality of experience (QoE) of the user. However, some of these events can be enhanced to allow a seamless transition without impacting the user experience or a transition with reduced impact on the user experience. Accelerating or speeding up these events can reduce latency and jitter in the XR traffic, thus, causing no disturbance or reduced disturbance of the user QoE. For example, enhancements to beam switching could be very helpful in allowing the switching to take place without the user noticing any impact on the quality of the XR video.

As illustrated in FIG. 3, XR traffic 305 between the UE 102 and the network entity 104 is a quasi-periodic traffic, which may have a periodicity, e.g., 30 fps, 60 fps or 120 fps. For example, the XR traffic 305 may include configured grant (CG)-physical uplink shared channel (PUSCH) 301A, 301B, 301C, 301D. The XR traffic 305 may arrive periodically, with some jitter. For example, the XR traffic 305 may include video frames. The UE 102 may transmit the video frames at certain times. There may be a transmission gap (e.g., a time interval) 317 without UL video transmission at the end of a first period 307A before the starting time of a second period 307B. Based on the characteristics of the XR traffic, there may be transmission gaps (e.g., time intervals) 317 with no UL transmission or DL transmissions. The events, which cause latency and jitter in the XR traffic and disturb the user QoE, may be accelerated or sped up to have a smaller window. Accelerating or speeding up the events, e.g., the beam switching, can reduce the latency and jitter in the XR traffic. Thus, the events have reduced impact or no impact on the XR communications, therefore causing reduced disturbance or no disturbance to the QoE of the user.

For example, accelerating the beam switching 318 can reduce the impact on the XR service QoE. The beam switching 318 may be accelerated or sped up. Thus, the beam switching 318 may have reduced impact or no impact on the UL or DL video transmission. In this way, the beam switching 318 may cause reduced disturbance or no disturbance to the QoE of the user.

For the beam switching, 3GPP specification supports the following operations for beam switching: beam indication from the network entity, UE-triggered beam failure recovery, and/or random access (RA) procedure (excluding PDCCH ordered PRACH (PCell) only). The network entity configures a list of transmission configuration indication (TCI) states by RRC signalling, where each TCI state includes at least one downlink reference signal resource index indicating at least one downlink reference signal resource. The network entity may transmit the downlink reference signals in different TCI states by different beams. The network entity provides the beam indication by indicating at least one of the TCI states in the TCI state list by a medium access control (MAC) control element (CE) or DCI signal. To complete the beam switching procedure, e.g., to apply the TCI state indicated by the network entity or the downlink reference corresponding to a beam failure recovery procedure or associated with the RA procedure, the UE may identify beam switching parameters. The beam switching parameters include a first parameter for the UE beam to correspond to the new NW beam, a second parameter for DL quasi co-location (QCL) Type A related parameters, and a third parameter for UL power control pathloss. To identify the first parameter, the UE may perform multiple measurement of the synchronization signal block (SSB), if the indicated beam (new beam) is unknown to the UE, e.g., not reported within a time window. The first parameter is for UE receive/transmit (Rx/Tx) beam. The network entity usually indicates a DL reference signal (RS) for both UL and DL beam indication. Then the UE identifies a UE beam corresponding to the DL RS. To identify the second parameter, the UE may track the SSB once. To identify the third parameter, the UE may measure the pathloss RS associated with the new beam multiple times, e.g., 5 times measurement of the SSB configured or determined as pathloss RS.

The delay for the UE to identify the beam switching parameters can cause latency and disturb the XR service. For the first parameter 1, the delay depends on whether the indicated TCI state is known or unknown. For known TCI state, this is assumed to be known by the UE already. For unknown TCI state, the delay could be 8*T SSB, where T_SSB indicates the SSB periodicity. It also depends on the discontinuous reception (DRX) configuration. Details are defined in section 8.10 in 3GPP 38.133. For the second parameter, the highest latency may be T_SSB. For the third parameter, the latency may be 5*T_SSB, using Layer 3 reference signal received power (L3-RSRP) for pathloss measurement. In total the range of the delay could be from T_SSB to 8*T_SSB, assuming there is no DRX impact. The UE measures the three beam switching parameters to finalize the beam switching procedure.

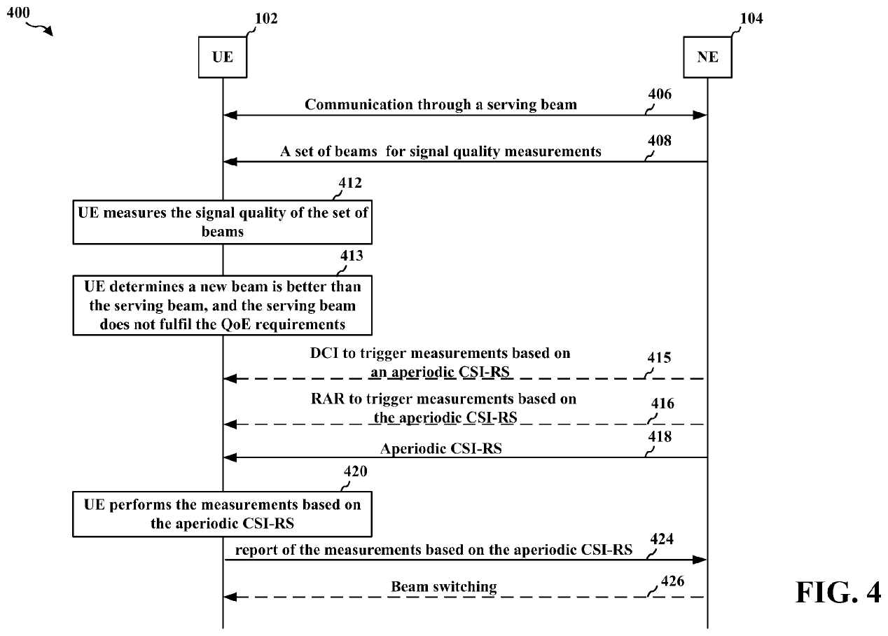

FIGS. 4-6 are a signaling diagrams illustrating examples of communications between a UE and a network entity for a beam switching acceleration. In some examples, a new beam is better than an old beam (e.g., the new beam has a higher signal quality than the old beam), and the old beam cannot provide good performance to support the XR service. Because the old beam cannot provide good performance for the XR service. The XR communications may have the low UL throughput or the high latency. The low UL throughput or the high latency may not be sufficient for the XR service. The link can still work but may not be good enough to fulfil the XR QoE requirements. In this situation, the UE and/or the network entity may accelerate or speed up the beam switching procedure to the new beam. The UE and/or the network entity may accelerate or speed up the procedure to identify the beam switching parameters to reduce the interruption time, e.g., to the XR communications.

FIG. 4 is a signaling diagram 400 illustrating an example of communications between a UE and a network entity for accelerating a beam switching by using an aperiodic CSI-RS. The network entity 104 may correspond to a base station or a unit of a base station, such as the RU 106, the DU 108, the CU 110, etc. In some examples, beam indication signalling, and/or BFR response, and/or RAR message can trigger the aperiodic CSI-RS to accelerate or speed up the procedure for identification of the beam switching parameters. The UE 102 may identify the beam switching parameters based on the aperiodic CSI-RS. DCI and/or RAR message may be enabled to trigger the aperiodic CSI measurement and reporting.

In some examples, the UE 102 and the network entity 104 may communicate 406 through a serving beam, e.g., the old beam or the ongoing beam. The UE 102 and the network entity 104 may transmit/receive data through the serving beam. The network entity 104 may send 408 a set of beams, e.g., multiple beams, for the UE to perform signal quality measurements, e.g., in the beam measurement procedure. The UE 102 may receive 408 the set of beams, e.g., multiple beams, to perform signal quality measurements.

The UE 102 measures 412 the signal quality of the set of beams by performing the signal quality measurements. For example, the UE may measure the synchronization signal blocks (SSBs). Each of the set of beams may include the SSBs or may be quasi-co-located with the SSBs. The UE determines 413 a new beam of the set of beams is better than the old beam based on the signal quality measurement. For example, the UE may determine the new beam is better than the old beam based on reference signal received power (RSRP) measurement.

The UE determines 413 whether the old beam can still provide good performance to support the XR traffic. The network entity may configure a threshold for the UE to determine whether the serving beam, e.g., the old beam, can still provide good performance to support the XR traffic. For example, the threshold may be a block error rate (BER) threshold, a packet error rate (PER) threshold, a BLER threshold, a L1-RSRP threshold, a L1-SINR threshold, a latency threshold, a packet data unit (PDU) set error rate (PSER) threshold, a PDU set latency threshold, a data burst error rate threshold, or a data burst latency threshold, etc. The network entity may configure the BER threshold, the PER threshold, the BLER threshold, the L1-RSRP threshold, the L1-SINR threshold, the latency threshold, the PSER threshold, the PDU set latency threshold, the data burst error rate threshold, or the data burst latency threshold for the UE to determine whether the old beam is still good. In another example, the network entity may configure the UE to determine the threshold. If the signal quality of the serving beam, e.g., the old beam, is below the threshold, the UE may determine that the serving beam, e.g., the old beam, can still provide good performance to support the XR traffic and fulfil the QoE requirements for the XR traffic. If the signal quality of the serving beam, e.g., the old beam, exceeds the threshold, the UE may determine that the serving beam, e.g., the old beam, cannot still provide good performance to support the XR traffic and cannot fulfil the QoE requirements for the XR traffic.

The UE may send the signal quality measurement report to the network entity, e.g., indicating the new beam. The network entity may send a beam indication signal, e.g., indicating the new beam, based on the signal quality measurement report.

In some examples, the UE 102 and/or the network entity 104 may use the aperiodic CSI-RS to accelerate or speed up the procedure to identify the beam switching parameters to reduce the interruption time. The network entity may provide the beam indication by indicating at least one of the TCI states in the TCI state list by an MAC CE or a DCI signal. To complete the beam switching procedure, e.g., to apply the TCI state indicated by the network entity or the downlink reference signal corresponding to a beam failure recovery procedure or associated with the RA procedure, the UE may identify the beam switching parameters. The beam switching parameters may include a first parameter for the UE beam to correspond to the new NW beam, a second parameter for DL quasi co-location (QCL) Type A related parameters, and a third parameter for UL power control pathloss.

The UE 102 may identify the beam switching parameters in order for the beam switching to happen. The UE 102 may identify the beam switching parameters using the periodic CSI-RS. However, the periodic CSI-RS are sent periodically. If the period of the CSI-RS is large or doesn't coincide with the small transmission gap 317, then after UE identifies that the old beam is not good enough, there may be no CSI-RS to measure due to the periodicity of the periodic CSI-RS. Thus, by using the aperiodic CSI-RS, the UE may identify the beam switching parameters as quickly as possible.

The TCI activation/indication delay may be reduced based on the aperiodic CSI-RS. Currently, TCI activation/indication delay is based on the periodic CSI-RS and SSB as a reference. The aperiodic CSI-RS may be used as a reference for the TCI activation/indication. By using the aperiodic CSI-RS as the reference, the TCI activation/indication delay may be reduced. The aperiodic CSI-RS may be used to trigger the measurements of the beam switching parameters.

For example, the network entity 104 may transmit 415 the DCI signal indicating the new beam to the UE. The DCI signal may include a bit field to trigger the measurements and reporting based on the aperiodic CSI-RS.

For example, the network entity 104 may transmit 416 a RAR message, which may include a bit field to trigger the measurements and reporting based on the aperiodic CSI-RS.

The network entity 104 may transmit 418 the aperiodic CSI-RS to the UE. The UE may receive 418 the aperiodic CSI-RS from the network entity. The UE may perform 420 the measurements based on the aperiodic CSI-RS. For example, the UE may perform measurements on CSI-RS resource indicator (CRI) and/or RSRP based on the aperiodic CSI-RS.

The UE 102 may transmit 424, to the network entity 104, a report of the measurements based on the aperiodic CSI-RS. The network entity 104 may receive 424, from the UE102, the report of the measurements based on the aperiodic CSI-RS. For example, the UE may report the measurements on CSI-RS resource indicator (CRI) and/or RSRP based on the aperiodic CSI-RS. By using the aperiodic CSI-RS, the UE may provide early CSI feedback to allows the new beam to be stable enough.

In some examples, the UE 102 may receive a beam switch message, e.g., a beam switch command, from the network entity 104, indicating, e.g., commanding, the UE to switch from old first beam to the new beam before or after the UE transmitting the report of the measurements based on the aperiodic CSI-RS. The network entity 104 may perform 426 the beam switching from the old beam to the new beam based on the report of the measurements based on the aperiodic CSI-RS.

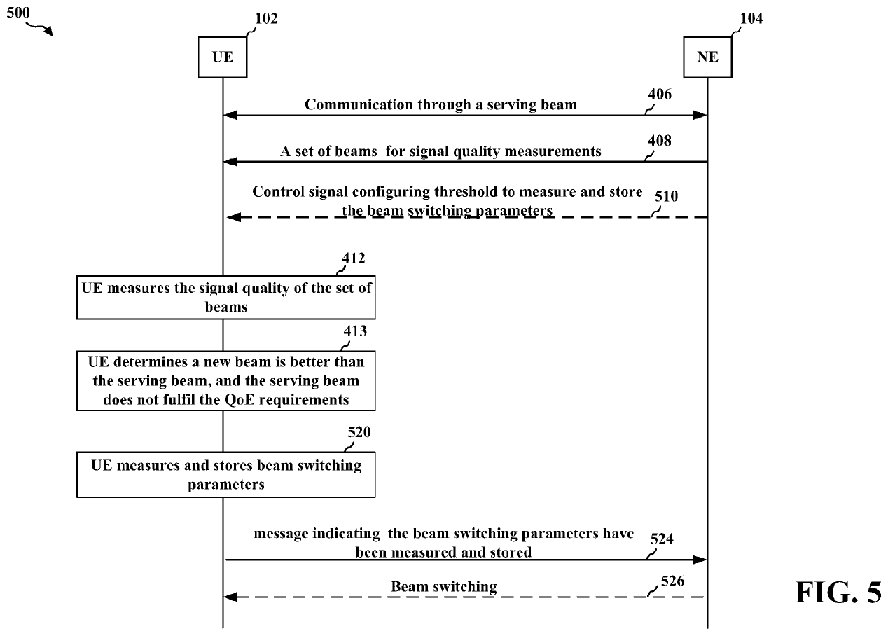

FIG. 5 is a signaling diagram 500 illustrating an example of communications between a UE and a network entity for accelerating a beam switching by measuring and storing the beam switching parameters during the beam measurement procedure before the beam switching procedure. The network entity 104 may correspond to a base station or a unit of a base station, such as the RU 106, the DU 108, the CU 110, etc. The UE 102 may measure and store the beam switching parameters in the beam measurement procedure (e.g., performing the signal quality measurements) and report whether the beam switching parameters are identified.

As discussed above, the UE 102 and the network entity 104 may communicate 406 through a serving beam, e.g., the old beam or the ongoing beam. The UE 102 and the network entity 104 may transmit/receive data through the serving beam. The network entity 104 may send 408 a set of beams, e.g., multiple beams, for the UE to perform signal quality measurements. The UE 102 may receive 408 the set of beams, e.g., multiple beams, to perform signal quality measurements, e.g., in the the beam measurement procedure. The UE 102 measures 412 the signal quality of the set of beams by performing the signal quality measurements. The UE determines 413 whether the old beam can still provide good performance to support the XR service. The UE may send the signal quality measurement report to the network entity, e.g., indicating the new beam. The network entity may send a beam indication signal, e.g., indicating the new beam, based on the signal quality measurement report.

The UE 102 may measure and store 520 the beam switching parameters in the beam measurement procedure (e.g., performing the signal quality measurements) before the beam switching procedure. The UE 102 may measure the beam switching parameters and store 520 the beam switching parameters in advance before the beam switching procedure. The UE may identify the beam switching parameters including include the first parameter for the UE beam to correspond to the new NW beam, the second parameter for DL quasi co-location (QCL) Type A related parameters, and the third parameter for UL power control pathloss. Before realizing that the old beam is not good enough, the UE has already performed the measurement of the beam switching parameters and stored the beam switching parameters. When the UE may decide the new beam, the UE 102 have already measured and stored the beam switching parameters. The beam switching latency may include the signal decoding latency, the UE beam change latency and the additional time to identify the beam switching parameters. By measuring and storing the beam switching parameters during the measurement stage (before beam indication signalling), the UE 102 may save the additional time to identify/track the beam switching parameters. Thus, the UE may accelerate a beam switching by measuring and storing the beam switching parameters during the beam measurement procedure.

The UE may select a portion (e.g., a part, a subset) of the plurality of beams to measure and store the corresponding beam switching parameters. For example, the portion (e.g., a part, a subset) of the plurality of beams may be the top N beams of the plurality of beams. The UE 102 may identify the most likely beam or the top N beams of the plurality of beams to measure and store the beam switching parameters, where N is an integer. Measuring and storing the beam switching parameters may take a lot of UE implementation effort. To reduce the complexity, the UE may select the portion (e.g., the part, the subset) of the plurality of beams to measure and store the beam switching parameters. In every beam measurement, UE may select beams that are the most likely beams to be the new beam if there is a beam switching. The UE may measure and store the beam switching parameters for each of the selected beams, in case one of the selected beams may become the new beam. For example, The UE may measure RSRP and select the top four beams which have the best RSRP. The UE may measure and store the beam switching parameters for each of the top four beams which have the best RSRP. As an example, the network entity may configure the UE to select the portion (e.g., the part, the subset) of the plurality of beams to measure and store the beam switching parameters.

The UE 102 may receive 510, from the network entity, a control signal configuring a first threshold for the UE to measure and store the beam switching parameters. The first threshold may include one of a block error rate (BER) threshold, a packet error rate (PER) threshold, a BLER threshold, a L1-RSRP threshold, a L1-SINR threshold, a latency threshold, a PSER threshold, a PDU set latency threshold, a data burst error rate threshold, or a data burst latency threshold, etc. The network entity 104 may define one or multiple conditions for the UE to start measuring and storing beam switching parameters. For example, the one or multiple conditions may include the threshold for link deterioration, the BER threshold, the PER threshold, the BLER threshold, the L1-RSRP threshold, the L1-SINR threshold, the latency threshold, the PSER threshold, the PDU set latency threshold, the data burst error rate threshold, or the data burst latency threshold, etc.

The UE 102 may transmit 524, to the network entity 104, a message indicating the UE has measured and stored the beam switching parameters for at least the portion of the plurality of beams before the beam switching procedure. The network entity 104 may receive 524, from the UE, the message indicating the UE has measured and stored the beam switching parameters for at least the portion of the plurality of beams before the beam switching procedure. The UE 102 may transmit, to the network entity, the message indicating whether the UE has identified the parameters for some specific beams, e.g., an indication whether the UE is ready for the beam switching. By measuring and storing the beam switching parameters during the measurement stage (before beam indication signalling), the UE 102 may accelerate the beam switching by saving the additional time to identify/track the beam switching parameters.

In some examples, the UE 102 may receive a beam switch message, e.g., a beam switch command, from the network entity 104, indicating, e.g., commanding, the UE to switch from old first beam to the new beam before or after transmitting the message indicating the UE has measured and stored the beam switching parameters. The network entity 104 may perform 526 the beam switching from the old beam to the new beam based on the message indicating the UE has measured and stored the beam switching parameters.

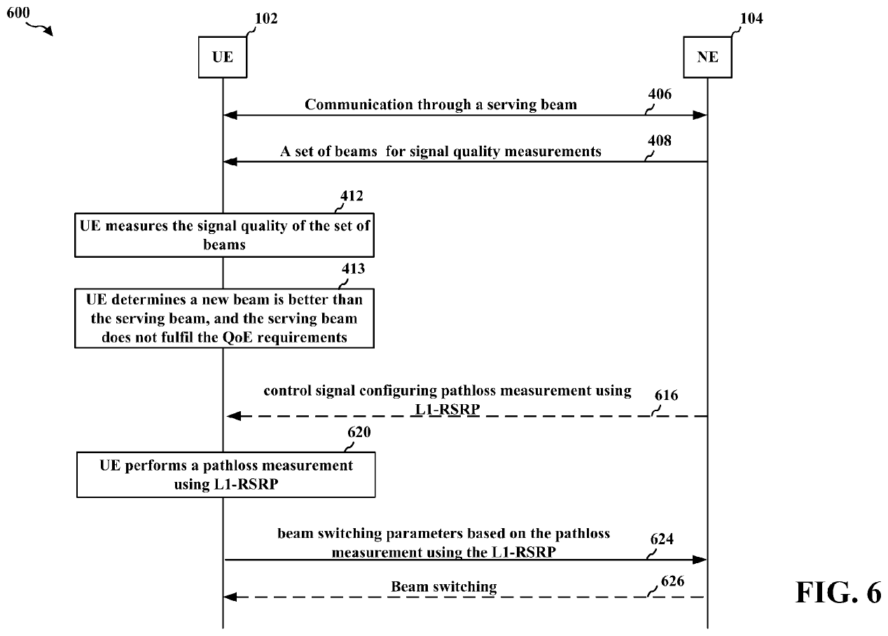

FIG. 6 is a signaling diagram 600 illustrating an example of communications between a UE and a network entity for accelerating a beam switching by using the L1-RSRP for the pathloss measurement. The network entity 104 may correspond to a base station or a unit of a base station, such as the RU 106, the DU 108, the CU 110, etc. The UE 102 may use the L1-RSRP for pathloss measurement to accelerate the beam switching procedure.

As discussed above, the UE 102 and the network entity 104 may communicate 406 through a serving beam, e.g., the old beam or the ongoing beam. The UE 102 and the network entity 104 may transmit/receive data through the serving beam. The network entity 104 may send 408 a set of beams, e.g., multiple beams, for the UE to perform signal quality measurements. The UE 102 may receive 408 the set of beams, e.g., multiple beams, to perform signal quality measurements. The UE 102 measures 412 the signal quality of the set of beams by performing the signal quality measurements. The UE determines 413 whether the old beam can still provide good performance to support the XR service. The UE may send 414 the signal quality measurement report to the network entity, e.g., indicating the new beam. The network entity may send 415 a beam indication signal, e.g., indicating the new beam, based on the signal quality measurement report.

The UE 102 may receive 616, from the network entity, a control signal configuring the pathloss measurement using the L1-RSRP. To accelerate the beam switching procedure, the UE and/or the network entity may relax some requirements. UE can use L1-RSRP for the pathloss measurement. To reduce the impact of the accuracy, the UE may have a receiver with an improved accuracy. The network entity may define a restriction for use the L1-RSRP for the pathloss measurement. The control signal may include the restriction for use the L1-RSRP for the pathloss measurement. As an example, the restriction may include the L1-RSRP may be for the pathloss measurement only for the transition time (before the UE measures the L3-RSRP). As another example, the restriction may include configuring a higher transmission power PO (e.g., uplink transmit power) during the transition time to make sure the UL performance for the UE is good enough. The network entity may configure the higher transmission PO during the transition time. Then, after the transition time, the transmission power PO can be re-adjusted. For example, the network entity can configure two values for the transmission power PO.

In some examples, the network entity can configure the use of L1-RSRP or L3-RSRP for the pathloss measurement. The network entity can configure using the L1-RSRP or L3-RSRP depending on the channel condition. For example, if the channel has a lot of fluctuation and using the L1-RSRP for the pathloss measurement may be too risky, the network entity may decide to use L3-RSRP for the pathloss measurement. If the channel is stable and no risk, the network entity may decide to use L1-RSRP for the pathloss measurement.

The UE 102 may perform 620 the pathloss measurement using the L1-RSRP. The pathloss measurement based on the L1-RSRP is less accurate than the pathloss measurement based on the L3-RSRP, but faster. The UE may use the L1-RSRP for the pathloss measurement only during the transition period.

The UE 102 may transmit 624, to the network entity 104, the beam switching parameters based on the pathloss measurement using the L1-RSRP. The network entity 104 may receive 624, from the UE, the beam switching parameters based on the pathloss measurement using the L1-RSRP.

In some examples, the UE 102 may receive a beam switch message, e.g., a beam switch command, from the network entity 104, indicating, e.g., commanding, the UE to switch from old first beam to the new beam before or after transmitting the message indicating the acceleration request to accelerate the beam switching for the subset of the communication channels. The network entity 104 may perform 626 the beam switching from the old beam to the new beam based on the beam switching parameters based on the pathloss measurement using the L1-RSRP.

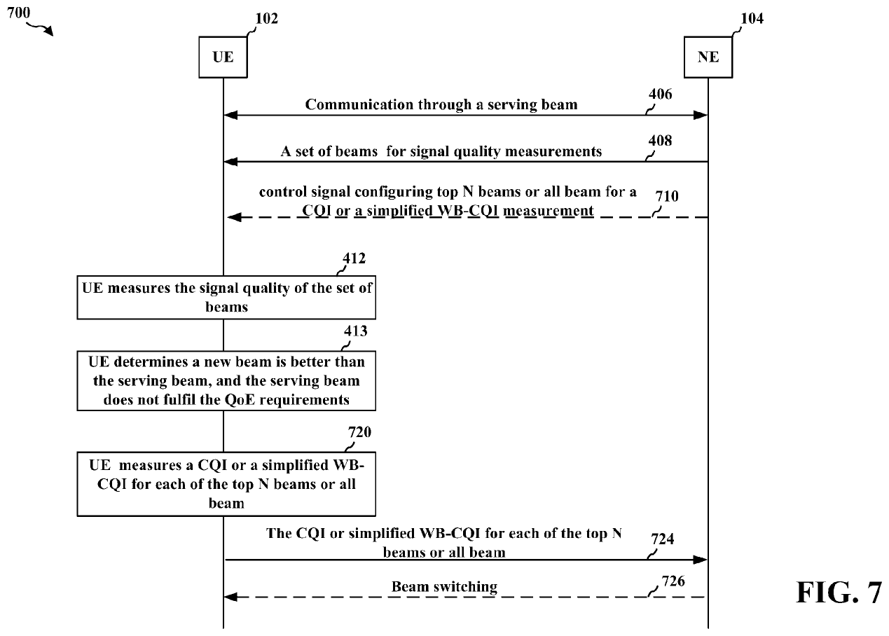

FIG. 7 is a signaling diagram illustrating an example of communications between a UE and a network entity for accelerating a beam switching based on a CQI or a simplified CQI. The network entity 104 may correspond to a base station or a unit of a base station, such as the RU 106, the DU 108, the CU 110, etc. The UE 102 may measure and report the CQI or the simplified CQI for each beam of the plurality of beams, e.g., to enable an early CSI report or an early modulation and coding scheme (MCS) selection, to accelerate the beam switching procedure.

As discussed above, the UE 102 and the network entity 104 may communicate 406 through a serving beam, e.g., the old beam or the ongoing beam. The UE 102 and the network entity 104 may transmit/receive data through the serving beam. The network entity 104 may send 408 a set of beams, e.g., multiple beams, for the UE to perform signal quality measurements. The UE 102 may receive 408 the set of beams, e.g., multiple beams, to perform signal quality measurements. The UE 102 measures 412 the signal quality of the set of beams by performing the signal quality measurements. The UE determines 413 whether the old beam can still provide good performance to support the XR service. The UE may send 414 the signal quality measurement report to the network entity, e.g., indicating the new beam. The network entity may send 415 a beam indication signal, e.g., indicating the new beam, based on the signal quality measurement report.

The UE 102 may measure 720 the CQI or the simplified CQI for each beam of the plurality of beams, e.g., SSB, in the beam measurement report, the BFR request and/or MsgA/MSg3. The UE 102 may measure the CQI or the simplified CQI in advance before the beam switching procedure. The simplified CQI may refer to the wideband (WB)-CQI, which is from one port: The network entity may select the MCS, e.g., for DL traffic based on the CQI or the simplified CQI. In some implementations, the UE may measure the simplified CQI based on a separate CQI table. In one example, the CQI table for the simplified CQI measurement may include fewer entries than the other types of CQI, e.g., the number of candidate CQIs for the simplified CQI may be 4 or 8. In another example implementation, a sub-table determined from the existing CQI table(s) is used for the simplified CQI reporting (e.g. every other CQI value in the table). The sub-table could be specified/pre-defined or configured by the base station (e.g., via RRC configuration, etc.). Measuring the CQI or the simplified CQI may save time for the CQI measurements and reporting after the beam is selected. Before the beam switching, the UE has already performed the measurement of the CQI or the simplified CQI. Thus, after the beam switching, the network entity may avoid the delay to wait for the CQI measurements and reporting. The network entity may accelerate the selection of the MCS. Therefore, the UE may accelerate the beam switching by measuring the CQI or the simplified CQI in the beam measurement procedure.

The UE 102 may receive 710, from the network entity, a control signal configuring the top N beams or all beams for the measurement of the CQI or the simplified CQI. The control signal may configure a portion (e.g., a subset, a part) of the plurality of beams for the measurement of the CQI or the simplified CQI. For example, the portion may include the top N beams of the plurality of beams. UE can measure and report for the top N beams or all beams. The number of beams N can be configured by the network. In some examples, the number of beams N can also be specified by a protocol, or configured by the network entity, or reported by the UE.

The UE 102 may transmit 724, to the network entity 104, a report indicating the CQI or the simplified wideband (WB)-CQI for at least a portion of the plurality of beams before the beam switching, to accelerate the MCS selection. The network entity 104 may receive 724, from the UE 102, the report indicating the CQI or the simplified wideband (WB)-CQI for at least a portion of the plurality of beams before the beam switching, to accelerate the MCS selection. The report may indicate the CQI or the simplified CQI for each beam of the top N beams or all of the plurality of beams.

In some examples, the UE 102 may receive a beam switch message, e.g., a beam switch command, from the network entity 104, indicating, e.g., commanding, the UE to switch from old first beam to the new beam before or after transmitting the message indicating the CQI or the simplified CQI. The network entity 104 may perform 726 the beam switching from the old beam to the new beam based on the message indicating the CQI or the simplified CQI for each beam of the top N beams or all of the plurality of beams.

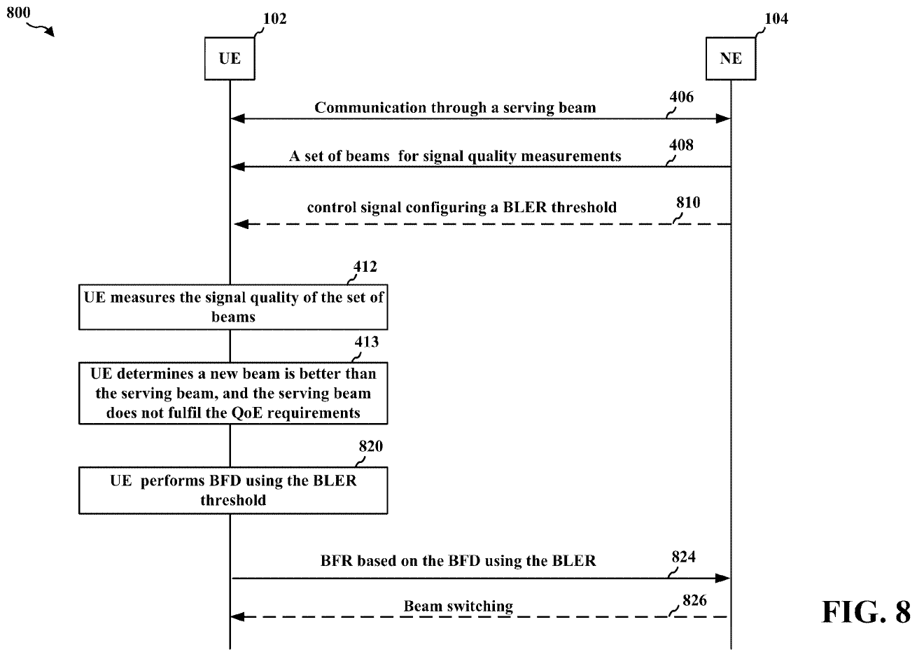

FIG. 8 is a signaling diagram illustrating an example of communications between a UE and a network entity for accelerating a beam switching by beam failure detection using a different BLER threshold. The network entity 104 may correspond to a base station or a unit of a base station, such as the RU 106, the DU 108, the CU 110, etc. The UE 102 may perform the beam failure detection (BFD) for the XR communications using a different target BLER to accelerate the beam switching.

As discussed above, the UE 102 and the network entity 104 may communicate 406 through a serving beam, e.g., the old beam or the ongoing beam. The UE 102 and the network entity 104 may transmit/receive data through the serving beam. The network entity 104 may send 408 a set of beams, e.g., multiple beams, for the UE to perform signal quality measurements. The UE 102 may receive 408 the set of beams, e.g., multiple beams, to perform signal quality measurements. The UE 102 measures 412 the signal quality of the set of beams by performing the signal quality measurements. The UE determines 413 whether the old beam can still provide good performance to support the XR service. The UE may send 414 the signal quality measurement report to the network entity, e.g., indicating the new beam. The network entity may send 415 a beam indication signal, e.g., indicating the new beam, based on the signal quality measurement report.

The UE 102 may receive 810, from the network entity, a control signal configuring the BLER threshold for the XR communications. The BLER threshold can be RRC signalling configured. For example, the network entity may transmit an RRC signal configuring the BLER threshold for the XR communications. The BLER threshold for the XR communications may be lower than that for other type of traffic.

The UE 102 may perform 820 the BFD using the BLER threshold for the XR communications. Since the BLER threshold for the XR communications may be lower than that for other type of traffic, the UE may accelerate the beam switching.

The UE 102 may transmit 824, to the network entity 104, a beam failure recovery request (BFRQ) based on the BFD using the BLER threshold for XR communications. The network entity 104 may receive 824, from the UE, the BFRQ based on the BFD using the BLER threshold for XR communications. In some examples, the network entity may configure two BLER thresholds for the BFD, e.g., a first BLER threshold for traffic other than XR and a second BLER threshold for XR traffic, in the BFRQ, the UE may report whether it is triggered based on the BFD on the first BLER threshold or the second BLER threshold. In this way, the QoE experience of XR users may be improved.

In some examples, the UE 102 may receive a beam switch message, e.g., a beam switch command, from the network entity 104, indicating, e.g., commanding, the UE to switch from old first beam to the new beam before or after transmitting the message indicating the acceleration request to accelerate the beam switching for the subset of the communication channels. The network entity 104 may perform 826 the beam switching from the old beam to the new beam based on the BFRQ based on the BFD using the BLER threshold for XR communications.

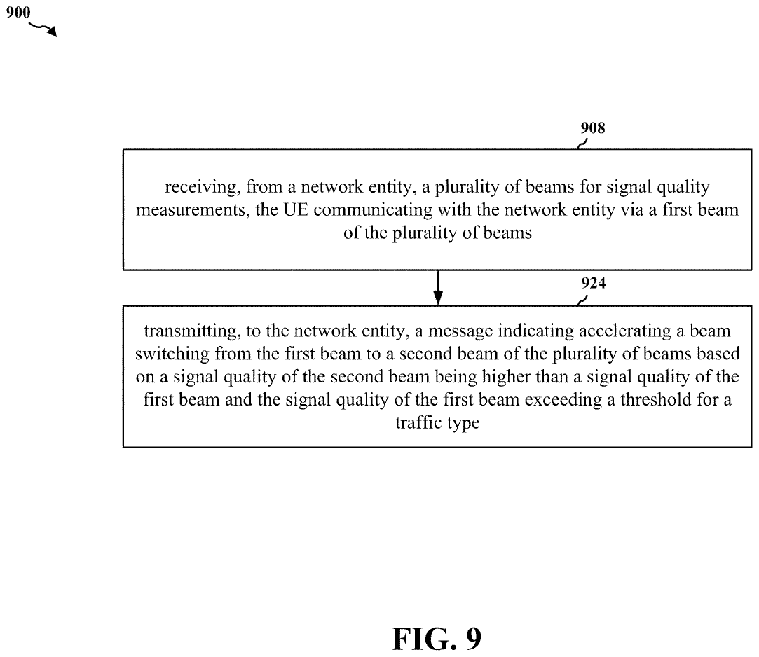

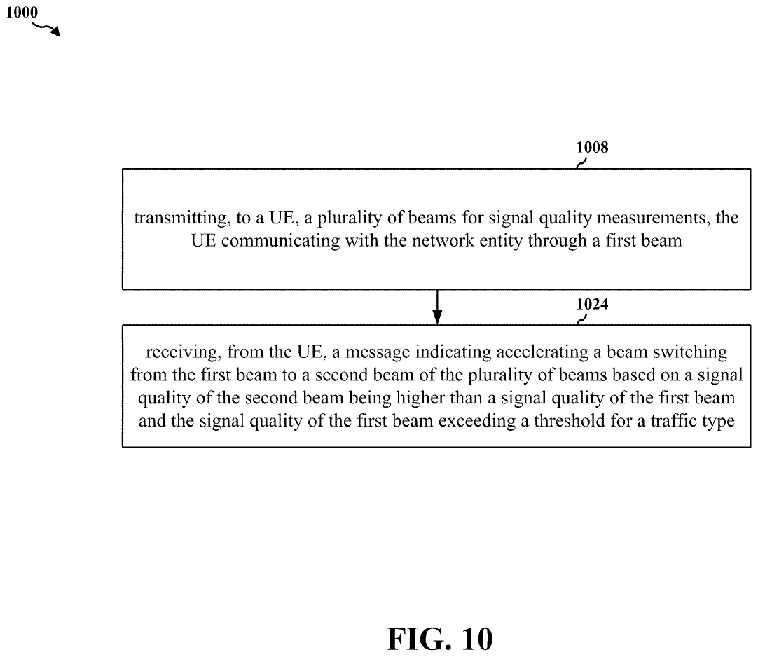

FIGS. 3-8 illustrate examples of communications between the UE and the network entity for accelerating the beam switching. FIGS. 9-10 show methods for implementing one or more aspects of FIGS. 3-8. In particular, FIG. 9 shows an implementation by the UE 102 of the one or more aspects of FIGS. 3-8. FIG. 10 shows an implementation by the network entity 104 of the one or more aspects of FIGS. 3-8.

FIG. 9 illustrates a flowchart 900 of a method of wireless communication at a UE. With reference to FIGS. 1-8 and 11, the method may be performed by the UE 102, the UE apparatus 1102, etc., which may include the memory 1126′, 1106′, 1116, and which may correspond to the entire UE 102 or the entire UE apparatus 1102, or a component of the UE 102 or the UE apparatus 1102, such as the wireless baseband processor 1126 and/or the application processor 1106.

The UE 102 receives 908, from a network entity, a plurality of beams for signal quality measurements. The UE communicates with the network entity via a first beam of the plurality of beams. For example, referring to FIGS. 4-8, the UE 102 may receive 408 the set of beams, e.g., multiple beams, to perform signal quality measurements.

The UE 102 transmits 924, to the network entity, a message indicating accelerating a beam switching from the first beam to a second beam of the plurality of beams based on a signal quality of the second beam being higher than a signal quality of the first beam and the signal quality of the first beam exceeding a threshold for a traffic type. For example, referring to FIG. 4, the UE 102 may transmit 424, to the network entity 104, a report of the measurements based on the aperiodic CSI-RS. For example, referring to FIG. 5, the UE 102 may transmit 524, to the network entity 104, a message indicating the UE has measured and stored the beam switching parameters for at least the portion of the plurality of beams before the beam switching procedure. For example, referring to FIG. 6, the UE 102 may transmit 624, to the network entity 104, the beam switching parameters based on the pathloss measurement using the L1-RSRP. For example, referring to FIG. 7, the UE 102 may transmit 724, to the network entity 104, a report indicating the CQI or the simplified wideband (WB)-CQI for at least a portion of the plurality of beams before the beam switching, to accelerate the MCS selection. For example, referring to FIG. 8, the UE 102 may transmit 824, to the network entity 104, a beam failure recovery request (BFRQ) based on the BFD using the BLER threshold for XR communications. FIG. 9 describes a method from a UE-side of a wireless communication link, whereas FIG. 10 describes a method from a network-side of the wireless communication link.

FIG. 10 is a flowchart 1000 of a method of wireless communication at a network entity. With reference to FIGS. 1-8 and 12, the method may be performed by one or more network entities 104, which may correspond to a base station or a unit of the base station, such as the RU 106, the DU 108, the CU 110, an RU processor 1206, a DU processor 1226, a CU processor 1246, etc. The one or more network entities 104 may include memory 1206′/1226′/1246′, which may correspond to an entirety of the one or more network entities 104, or a component of the one or more network entities 104, such as the RU processor 1206, the DU processor 1226, or the CU processor 1246.

The network entity 104 transmits 1008, to a UE, a plurality of beams for signal quality measurements. The network entity communicates with the UE via a first beam of the plurality of beams. For example, referring to FIGS. 4-8, the network entity 104 may send 408 a set of beams, e.g., multiple beams, for the UE to perform signal quality measurements.

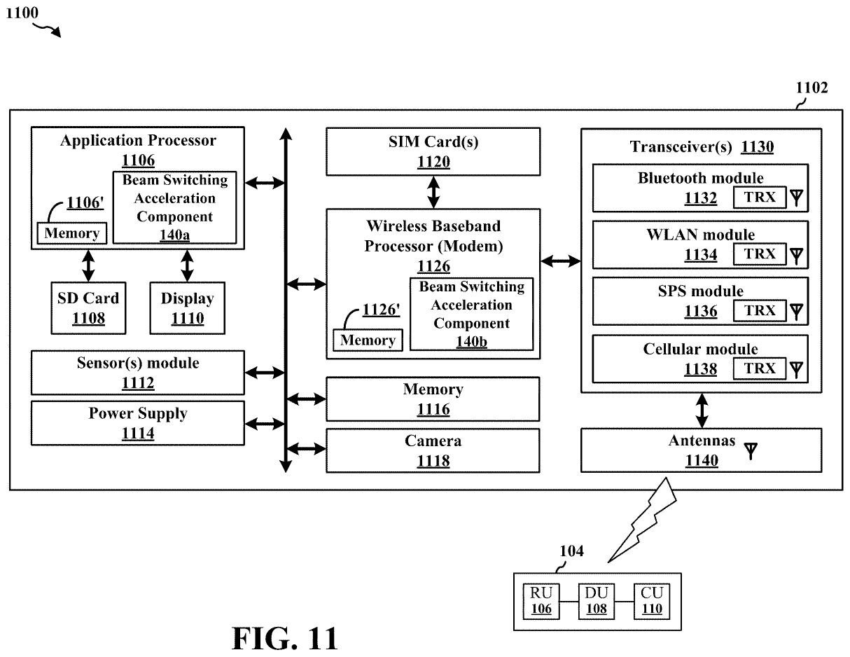

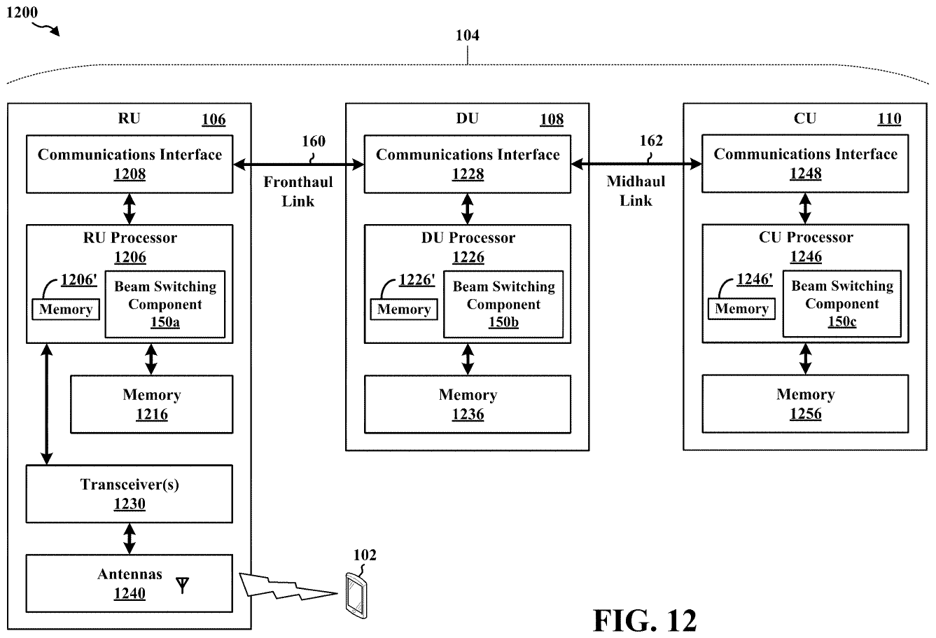

The network entity 104 receives 1024, from the UE, a message indicating accelerating a beam switching from the first beam to a second beam of the plurality of beams based on a signal quality of the second beam being higher than a signal quality of the first beam and the signal quality of the first beam exceeding a threshold for a traffic type. For example, referring to FIG. 4, the network entity 104 may receive 424, from the UE 102, the report of the measurements based on the aperiodic CSI-RS. For example, referring to FIG. 5, the network entity 104 may receive 524, from the UE, the message indicating the UE has measured and stored the beam switching parameters for at least the portion of the plurality of beams before the beam switching procedure. For example, referring to FIG. 6, the network entity 104 may receive 624, from the UE, the beam switching parameters based on the pathloss measurement using the L1-RSRP. For example, referring to FIG. 7, the network entity 104 may receive 724, from the UE 102, the report indicating the CQI or the simplified wideband (WB)-CQI for at least a portion of the plurality of beams before the beam switching, to accelerate the MCS selection. For example, referring to FIG. 8, the network entity 104 may receive 824, from the UE, the BFRQ based on the BFD using the BLER threshold for XR communications. A UE apparatus 1102, as described in FIG. 11, may perform the method of flowchart 900. The one or more network entities 104, as described in FIG. 12, may perform the method of flowchart 1100.

FIG. 11 is a diagram 1100 illustrating an example of a hardware implementation for a UE apparatus 1102. The UE apparatus 1102 may be the UE 102, a component of the UE 102, or may implement UE functionality. The UE apparatus 1102 may include an application processor 1106, which may have on-chip memory 1106′. In examples, the application processor 1106 may be coupled to a secure digital (SD) card 1108 and/or a display 1110. The application processor 1106 may also be coupled to a sensor(s) module 1112, a power supply 1114, an additional module of memory 1116, a camera 1118, and/or other related components. For example, the sensor(s) module 1112 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1102 may further include a wireless baseband processor 1126, which may be referred to as a modem. The wireless baseband processor 1126 may have on-chip memory 1126′. Along with, and similar to, the application processor 1106, the wireless baseband processor 1126 may also be coupled to the sensor(s) module 1112, the power supply 1114, the additional module of memory 1116, the camera 1118, and/or other related components. The wireless baseband processor 1126 may be additionally coupled to one or more subscriber identity module (SIM) card(s) 1120 and/or one or more transceivers 1130 (e.g., wireless RF transceivers).

Within the one or more transceivers 1130, the UE apparatus 1102 may include a Bluetooth module 1132, a WLAN module 1134, an SPS module 1136 (e.g., GNSS module), and/or a cellular module 1138. The Bluetooth module 1132, the WLAN module 1134, the SPS module 1136, and the cellular module 1138 may each include an on-chip transceiver (TRX), or in some cases, just a transmitter (TX) or just a receiver (RX). The Bluetooth module 1132, the WLAN module 1134, the SPS module 1136, and the cellular module 1138 may each include dedicated antennas and/or utilize antennas 1140 for communication with one or more other nodes. For example, the UE apparatus 1102 can communicate through the transceiver(s) 1130 via the antennas 1140 with another UE (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1126 and the application processor 1106 may each include a computer-readable medium/memory 1126′, 1106′, respectively. The additional module of memory 1116 may also be considered a computer-readable medium/memory. Each computer-readable medium/memory 1126′, 1106′, 1116 may be non-transitory. The wireless baseband processor 1126 and the application processor 1106 may each be responsible for general processing, including execution of software stored on the computer-readable medium/memory 1126′, 1106′, 1116. The software, when executed by the wireless baseband processor 1126/application processor 1106, causes the wireless baseband processor 1126/application processor 1106 to perform the various functions described herein. The computer-readable medium/memory may also be used for storing data that is manipulated by the wireless baseband processor 1126/application processor 1106 when executing the software. The wireless baseband processor 1126/application processor 1106 may be a component of the UE 102. The UE apparatus 1102 may be a processor chip (e.g., modem and/or application) and include just the wireless baseband processor 1126 and/or the application processor 1106. In other examples, the UE apparatus 1102 may be the entire UE 102 and include the additional modules of the apparatus 1102.

As discussed in FIG. 1 and implemented with respect to FIG. 9, the beam switching acceleration component 140 is configured to receive, from the network entity, a plurality of beams for signal quality measurements. The UE 102 communicates with the network entity via a first beam of the plurality of beams. The beam switching acceleration component 140 is further configured to transmit, to the network entity, a message indicating accelerating a beam switching from the first beam to a second beam of the plurality of beams based on a signal quality of the second beam being higher than a signal quality of the first beam and the signal quality of the first beam exceeding a threshold for a traffic type. The beam switching acceleration component 140 may be within the application processor 1106 (e.g., at 140a), the wireless baseband processor 1126 (e.g., at 140b), or both the application processor 1106 and the wireless baseband processor 1126. The beam switching acceleration component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

FIG. 12 is a diagram 1200 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1246, which may have on-chip memory 1246′. In some aspects, the CU 110 may further include an additional module of memory 1256 and/or a communications interface 1248, both of which may be coupled to the CU processor 1246. The CU 110 can communicate with the DU 108 through a midhaul link 162, such as an F1 interface between the communications interface 1248 of the CU 110 and a communications interface 1228 of the DU 108.

The DU 108 may include a DU processor 1226, which may have on-chip memory 1226′. In some aspects, the DU 108 may further include an additional module of memory 1236 and/or the communications interface 1228, both of which may be coupled to the DU processor 1226. The DU 108 can communicate with the RU 106 through a fronthaul link 160 between the communications interface 1228 of the DU 108 and a communications interface 1208 of the RU 106.

The RU 106 may include an RU processor 1206, which may have on-chip memory 1206′. In some aspects, the RU 106 may further include an additional module of memory 1216, the communications interface 1208, and one or more transceivers 1230, all of which may be coupled to the RU processor 1206. The RU 106 may further include antennas 1240, which may be coupled to the one or more transceivers 1230, such that the RU 106 can communicate through the one or more transceivers 1230 via the antennas 1240 with the UE 102.

The on-chip memory 1206′, 1226′, 1246′ and the additional modules of memory 1216, 1236, 1256 may each be considered a computer-readable medium/memory. Each computer-readable medium/memory may be non-transitory. Each of the processors 1206, 1226, 1246 is responsible for general processing, including execution of software stored on the computer-readable medium/memory. The software, when executed by the corresponding processor(s) 1206, 1226, 1246 causes the processor(s) 1206, 1226, 1246 to perform the various functions described herein. The computer-readable medium/memory may also be used for storing data that is manipulated by the processor(s) 1206, 1226, 1246 when executing the software. In examples, the beam switching component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed in FIG. 1 and implemented with respect to FIG. 10, the beam switching component 150 is configured to transmit, to the UE 102, a plurality of beams for signal quality measurements. The network entity communicates with the UE via a first beam of the plurality of beams. The beam switching component 150 is further configured to receive, from the UE, a message indicating accelerating a beam switching from the first beam to a second beam of the plurality of beams based on a signal quality of the second beam being higher than a signal quality of the first beam and the signal quality of the first beam exceeding a threshold for a traffic type. The beam switching component 150 may be within one or more processors of the one or more network entities 104, such as the RU processor 1206 (e.g., at 150a), the DU processor 1226 (e.g., at 150b), and/or the CU processor 1246 (e.g., at 150c). The beam switching component 150a-150c may be one or more hardware components specifically configured to carry out the stated processes/algorithm, implemented by one or more processors 1206, 1226, 1246 configured to perform the stated processes/algorithm, stored within a computer-readable medium for implementation by the one or more processors 1206, 1226, 1246, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used in this disclosure, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of wireless communication at a UE, including: receiving, from a network entity, a plurality of beams for signal quality measurements, the UE communicating with the network entity via a first beam of the plurality of beams; and
transmitting, to the network entity, a message indicating accelerating a beam switching from the first beam to a second beam of the plurality of beams based on a signal quality of the second beam being higher than a signal quality of the first beam and the signal quality of the first beam exceeding a threshold for a traffic type.

Example 2 may be combined with example 1 and further includes the transmitting, to the network entity, a message indicating accelerating the beam switching comprises: transmitting, to the network entity, a report of measurements based on an aperiodic channel state information reference signal (CSI-RS).

Example 3 may be combined with example 2 and further includes receiving, from the network, a downlink control information (DCI) signal including a bit field to trigger the measurements based on the aperiodic CSI-RS; and receiving, from the network entity, the aperiodic CSI-RS for the measurements based on the aperiodic CSI-RS.

Example 4 may be combined with example 2 and further includes receiving, from the network, a random access response (RAR) message including a bit field to trigger the measurements based on the aperiodic CSI-RS; and receiving, from the network entity, the aperiodic CSI-RS for the measurements based on the aperiodic CSI-RS.

Example 5 may be combined with example 1 and further includes the transmitting, to the network entity, a message indicating accelerating the beam switching comprises: transmitting, to the network entity, a message indicating the UE has measured and stored the beam switching parameters for at least the portion of the plurality of beams before the beam switching.

Example 6 may be combined with example 15 and further include receiving, from the network entity, a control signal configuring a first threshold for the UE to measure and store the beam switching parameters, the first threshold being one of a block error rate (BLER) threshold, a packet error rate (PER) threshold, or a latency threshold.

Example 7 may be combined with any of examples 5-6 and further includes measuring and storing beam switching parameters for at least a portion of the plurality of beams before the beam switching.

Example 8 may be combined with example 1 and further includes the transmitting, to the network entity, a message indicating accelerating the beam switching comprises: transmitting, to the network entity, beam switching parameters based on a pathloss measurement using a Layer 1-reference signal received power (L1-RSRP).

Example 9 may be combined with example 8 and further includes receiving, from the network entity, a control signal configuring the pathloss measurement using the L1-RSRP; and performing the pathloss measurement using the L1-RSRP.

Example 10 may be combined with example 1 and further includes the transmitting, to the network entity, a message indicating accelerating the beam switching comprises: transmitting, to the network entity, a report indicating a channel quality indicator (CQI) or a simplified wideband (WB)-CQI for at least a portion of the plurality of beams before the beam switching, to accelerate a modulation and coding scheme (MCS) selection.

Example 11 may be combined with example 11 and further includes the CQI or the simplified WB-CQI is measured for the portion of the plurality of beams, the method further comprising: receiving, from the network entity, a control signal configuring the portion of the plurality of beams.

Example 12 may be combined with example 1 and further includes the transmitting, to the network entity, a message indicating accelerating the beam switching comprises: transmitting, to the network entity, a beam failure recovery request (BFRQ) based on a beam failure detection (BFD) using a block error rate (BLER) threshold for extended reality (XR) communications.

Example 13 may be combined with example 12 and further includes receiving, from the network entity, a control signal configuring the BLER threshold for the XR communications; and performing the BFD using the BLER threshold for the XR communications.

Example 14 is a method of wireless communication at a network entity, including: transmitting, to a user equipment (UE), a plurality of beams for signal quality measurements, the network entity communicating with the UE via a first beam of the plurality of beams; and receiving, from the UE, a message indicating accelerating a beam switching from the first beam to a second beam of the plurality of beams based on a signal quality of the second beam being higher than a signal quality of the first beam and the signal quality of the first beam exceeding a threshold for a traffic type.

Example 15 may be combined with example 14 and further includes the receiving, from the UE, a message indicating accelerating the beam switching comprises: receiving, from the UE, a report of measurements based on an aperiodic channel state information reference signal (CSI-RS).

Example 16 may be combined with example 15 and further includes transmitting, to the UE, a downlink control information (DCI) signal including a bit field to trigger the measurements based on the aperiodic CSI-RS; and transmitting, to the UE, the aperiodic CSI-RS for the measurements based on the aperiodic CSI-RS.

Example 17 may be combined with example 15 and further includes transmitting, to the UE, a random access response (RAR) message including a bit field to trigger the measurements based on the aperiodic CSI-RS; and transmitting, to the UE, the aperiodic CSI-RS for the measurements based on the aperiodic CSI-RS.

Example 18 may be combined with example 14 and further includes the receiving, from the UE, a message indicating accelerating the beam switching comprises: receiving, from the UE, a message indicating the UE has measured and stored the beam switching parameters for at least the portion of the plurality of beams before the beam switching.

Example 19 may be combined with example 18 and further includes transmitting, to the UE, a control signal configuring a first threshold for the UE to measure and store the beam switching parameters, the first threshold being one of a block error rate (BLER) threshold, a packet error rate (PER) threshold, or a latency threshold.

Example 20 may be combined with example 14 and further includes the receiving, from the UE, a message indicating accelerating the beam switching comprises: receiving, from the UE, beam switching parameters based on a pathloss measurement using a Layer 1-reference signal received power (L1-RSRP).

Example 21 may be combined with example 20 and further includes transmitting, to the UE, a control signal configuring the pathloss measurement using the L1-RSRP.

Example 22 may be combined with example 14 and further includes the receiving, from the UE, a message indicating accelerating the beam switching comprises: receiving, from the UE, a report indicating a channel quality indicator (CQI) or a simplified wideband (WB)-CQI for at least a portion of the plurality of beams before the beam switching, to accelerate a modulation and coding scheme (MCS) selection.

Example 23 may be combined with example 22 and further includes the CQI or the simplified WB-CQI is measured for the portion of the plurality of beams, the method further comprising: transmitting, to the UE, a control signal configuring the portion of the plurality of beams.

Example 24 may be combined with example 14 and further includes the receiving, from the UE, a message indicating accelerating the beam switching comprises: receiving (824), from the UE, a beam failure recovery request (BFRQ) based on a beam failure detection (BFD) using a block error rate (BLER) threshold for extended reality (XR) communications.

Example 25 may be combined with example 24 and further includes transmitting, to the UE, a control signal configuring the BLER threshold for the XR communications.

Example 26 may be combined with any of examples 1-13 and further includes receiving a beam switch signal from the network entity, indicating the UE to switch from the first beam to the second beam before or after transmitting the message.

Example 27 may be combined with any of the examples 14-25 and further includes transmitting a beam switch signal to the UE, indicating the UE to switch from the first beam to the second beam before or after receiving the message.

Example 28 is an apparatus for wireless communication comprising a transceiver, a memory, and a processor coupled to the memory and the transceiver, the apparatus being configured to implement a method as in any of examples 1-27.

Example 29 is an apparatus for wireless communication including means for implementing a method as in any of examples 1-27.

Example 30 is a non-transitory computer-readable medium storing computer executable code, the code when executed by a processor causes the processor to implement a method as in any of examples 1-27.

What is claimed is:

1. A method of wireless communication at a user equipment (UE) comprising:
receiving, from a network entity, a plurality of beams for signal quality measurements, the UE communicating with the network entity via a first beam of the plurality of beams; and
transmitting, to the network entity, a message indicating accelerating a beam switching from the first beam to a second beam of the plurality of beams based on a quasi co-location (QCL) parameter being stored at the UE for at least a portion of the plurality of beams.

2. The method of claim 1, wherein the transmitting, to the network entity, the message indicating accelerating the beam switching is further based on a signal quality of the second beam being higher than a signal quality of the first beam, and the signal quality of the first beam exceeding a threshold for a traffic type and comprises:
transmitting, to the network entity, a report of measurements based on an aperiodic channel state information reference signal (CSI-RS).

3. The method of claim 2, further comprising:
receiving, from the network entity, a downlink control information, DCI, signal including a bit field to trigger the measurements based on the aperiodic CSI-RS; and
receiving, from the network entity, the aperiodic CSI-RS for the measurements based on the aperiodic CSI-RS.

4. The method of claim 2, further comprising:
receiving, from the network entity, a random access response, RAR, message including a bit field to trigger the measurements based on the aperiodic CSI-RS; and
receiving, from the network entity, the aperiodic CSI-RS for the measurements based on the aperiodic CSI-RS.

5. The method of claim 1, wherein the transmitting, to the network entity, the message indicating accelerating the beam switching further comprises:
transmitting, to the network entity, the message indicating the UE has measured and stored beam switching parameters for at least the portion of the plurality of beams before the beam switching, the beam switching parameters including the QCL parameter.

6. The method of claim 5, further comprising:
receiving, from the network entity, a control signal configuring a first threshold for the UE to measure and store the beam switching parameters, the first threshold being one of a block error rate (BLER) threshold, a packet error rate (PER) threshold, or a latency threshold.

7. The method of claim 5, further comprising:
measuring and storing the beam switching parameters for at least the portion of the plurality of beams before the beam switching.

8. The method of claim 1, wherein the transmitting, to the network entity, the message indicating accelerating the beam switching comprises:
transmitting, to the network entity, beam switching parameters based on a pathloss measurement using a Layer 1-reference signal received power (L1-RSRP).

9. The method of claim 8, further comprising:
receiving, from the network entity, a control signal configuring the pathloss measurement using the L1-RSRP; and
performing the pathloss measurement using the L1-RSRP.

10. The method of claim 1, wherein the transmitting, to the network entity, the message indicating accelerating the beam switching comprises:
transmitting, to the network entity, a report indicating a channel quality indicator (CQI) or a simplified wideband CQI (WB-CQI) for at least the portion of the plurality of beams before the beam switching, to accelerate a modulation and coding scheme (MCS) selection.

11. The method of claim 10, wherein the CQI or the simplified WB-CQI is measured for the portion of the plurality of beams, the method further comprising:
receiving, from the network entity, a control signal configuring the portion of the plurality of beams.

12. The method of claim 1, wherein the transmitting, to the network entity, the message indicating accelerating the beam switching comprises:
transmitting, to the network entity, a beam failure recovery request, BFRQ, based on a beam failure detection (BFD) using a block error rate (BLER) threshold for extended reality (XR) communications.

13. The method of claim 12, further comprising:
receiving, from the network entity, a control signal configuring the BLER threshold for the XR communications; and
performing the BFD using the BLER threshold for the XR communications.

14. A method of wireless communication at a network entity, comprising:
transmitting, to a user equipment (UE) a plurality of beams for signal quality measurements, the network entity communicating with the UE via a first beam of the plurality of beams; and
receiving, from the UE, a message indicating accelerating a beam switching from the first beam to a second beam of the plurality of beams based on a quasi co-location (QCL) parameter being stored at the UE for at least a portion of the plurality of beams.

15. The method of claim 14, wherein the receiving, from the UE, the message indicating accelerating the beam switching is further based on a signal quality of the second beam being higher than a signal quality of the first beam, and the signal quality of the first beam exceeding a threshold for a traffic type and comprises:
receiving, from the UE, a report of measurements based on an aperiodic channel state information reference signal (CSI-RS).

16. The method of claim 14, wherein the receiving, from the UE, the message indicating accelerating the beam switching comprises:
receiving, from the UE, a message indicating the UE has measured and stored beam switching parameters for at least the portion of the plurality of beams before the beam switching, the beam switching parameters including the QCL parameter.

17. The method of claim 14, wherein the receiving, from the UE, the message indicating accelerating the beam switching comprises:
receiving, from the UE, beam switching parameters based on a pathloss measurement using a Layer 1-reference signal received power (L1-RSRP).

18. The method of claim 14, wherein the receiving, from the UE, the message indicating accelerating the beam switching comprises:
receiving, from the UE, a report indicating a channel quality indicator (CQI) or a simplified wideband CQI (WB-CQI), for at least the portion of the plurality of beams before the beam switching, to accelerate a modulation and coding scheme (MCS) selection.

19. The method of claim 14, wherein the receiving, from the UE, the message indicating accelerating the beam switching comprises:
receiving, from the UE, a beam failure recovery request (BFRQ) based on a beam failure detection (BFD) using a block error rate (BLER) threshold for extended reality (XR) communications.

20. An apparatus for wireless communication at a user equipment (UE), comprising: a transceiver;
a processor; and
a memory coupled to the processor to store instructions, which when executed by the processor, cause the processor to:
receive, from a network entity, a plurality of beams for signal quality measurements, the UE communicating with the network entity via a first beam of the plurality of beams; and
transmit, to the network entity, a message indicating accelerating a beam switching from the first beam to a second beam of the plurality of beams based on a quasi co-location (QCL) parameter being stored at the UE for at least a portion of the plurality of beams.
